(19) United States
(12) Patent Application Publication
(10) Pub. No.: US 2025/0373537 A1
(43) Pub. Date: Dec. 4, 2025

(54) ENERGY SCORING OF NETWORK PATHS

(71) Applicant: Cisco Technology, Inc., San Jose, CA (US)

(72) Inventors: Alberto Rodriguez-Natal, BARCELONA (ES); Eric A. Voit, Bethesda, MD (US); Marisol Palmero Amador, MADRID (ES); Pradeep K. Kathail, Los Altos, CA (US)

(21) Appl. No.: 18/781,701

(22) Filed: Jul. 23, 2024

Related U.S. Application Data
(60) Provisional application No. 63/655,492, filed on Jun. 3, 2024.

(51) Int. Cl. H04L 45/12; H04L 41/14

(52) U.S. Cl. CPC H04L 45/123; H04L 41/14

(57) ABSTRACT

Devices, systems, methods, and processes for energy scoring of network paths are described herein. Various network paths, each including one or more hops, may be identified in a network. Presence of additional hops in each network path may be determined. From the identified and determined hops, a set of hops may be determined for energy score determination. For each selected hop, a set of energy parameters may be determined and one or more weights may be assigned to the determined set of energy parameters. A weight may correspond to a level of confidence in or an accuracy of the energy parameter determination. An energy score of each network path may be determined based on the determined set of energy parameters and the assigned one or more weights. One network path may be selected based on the energy scores and traffic may be routed along the selected network path.

The present disclosure relates to networking. More particularly, the present disclosure relates to energy scoring of network paths.

This application claims the benefit of U.S. Provisional Patent Application No. 63/655,492, filed Jun. 3, 2024, which is incorporated by reference herein in its entirety.

### BACKGROUND

Networks are interconnected systems that enable communication and data exchange between multiple devices. Networks can be wired or wireless. Further, these networks can be classified based on their size and scope, ranging from small local area networks within a single building to extensive wide area networks that span the globe. To ensure efficient, secure, and accurate data transmission, networks may rely on a variety of protocols and standards, including Transmission Control Protocol/Internet Protocol (“TCP/IP”), Ethernet, wireless fidelity (“Wi-Fi”), or the like.

In the current industrial landscape, environmental sustainability is fast becoming a topic of interest. Environmental sustainability may be important for ensuring the long-term health and viability of the planet. Environmental sustainability can involve managing natural resources responsibly to meet current needs without compromising the ability of future generations to meet theirs. By adopting sustainable practices, the effects of climate change can be mitigated, and the natural habitats that countless species, including humans, depend on can be prevented.

Hence, there may be a growing impetus for network operators to manage the carbon footprint of the networks. The carbon footprint is a measure of the total amount of greenhouse gas emissions generated throughout the lifecycle of network infrastructure and operations. The carbon footprint management in the networks can be leveraged to align with sustainability objectives.

### SUMMARY OF THE DISCLOSURE

Systems and methods for energy scoring of network paths in accordance with embodiments of the disclosure are described herein.

In many embodiments, a device may include a processor, a network interface controller configured to provide access to a network, and a memory communicatively coupled to the processor. The memory comprises a network management logic that is configured to identify, in the network, at least one network path comprising one or more hops. The network management logic is further configured to determine a set of energy parameters associated with at least one hop of the one or more hops, assign one or more weights to the determined set of energy parameters, and determine an energy score of the at least one network path based on the determined set of energy parameters and the assigned one or more weights.

In a number of embodiments, the network management logic is further configured to route traffic along the at least one network path based on the determined energy score.

In a variety of embodiments, determining the energy score based on the determined set of energy parameters and the assigned one or more weights comprises comparing the assigned one or more weights with a weight threshold and determining, in response to at least one of the assigned one or more weights being greater than the weight threshold, a carbon intensity of the at least one hop based on the determined set of energy parameters. The energy score of the at least one network path is determined based on the carbon intensity of the at least one hop.

In more embodiments, the energy score is configured to indicate a number of hops of the at least one network path that have carbon intensities greater than a carbon threshold.

In additional embodiments, the one or more hops conform to a network topology.

In further embodiments, the network management logic is further configured to compare the network topology with a reference topology associated with the at least one network path.

In still more embodiments, the set of energy parameters associated with the at least one hop is determined in response to the at least one hop in the network topology being within a threshold range of another hop in the reference topology.

In still further embodiments, to determine the energy score of the at least one network path, the network management logic is further configured to determine presence of one or more additional hops in the at least one network path along with the one or more hops. The energy score of the at least one network path is further determined based on the one or more additional hops.

In still additional embodiments, the set of energy parameters comprises at least one of a geolocation or one or more energy sources associated with the at least one hop.

In some more embodiments, the network management logic is further configured to determine the one or more energy sources based on the geolocation.

In yet more embodiments, in response to the set of energy parameters comprising the geolocation associated with the at least one hop, the one or more weights comprise a location weight assigned to the geolocation.

In still yet more embodiments, the network management logic is further configured to compare the location weight with a location threshold. The one or more energy sources associated with the at least one hop are determined in response to the location weight being greater than the location threshold.

In many further embodiments, in response to the set of energy parameters comprising the one or more energy sources associated with the at least one hop, the one or more weights comprise an energy source weight assigned to the one or more energy sources.

In many additional embodiments, the network management logic is further configured to compare the energy source weight with an energy source threshold and determine, in response to the energy source weight being greater than the energy source threshold, a carbon intensity of the at least one hop based on the one or more energy sources.

In still yet further embodiments, the network management logic is further configured to compare the location weight with a location threshold and assign a location factor to the at least one hop based on the comparison of the location weight with the location threshold.

In still yet additional embodiments, the network management logic is further configured to compare the energy source weight with an energy source threshold and assign an energy source factor to the at least one hop based on the comparison of the energy source weight with the energy source threshold.

In several embodiments, the network management logic is further configured to determine a carbon intensity associated with the at least one hop based on the one or more energy sources, compare the determined carbon intensity with a carbon threshold, and assign a carbon factor to the at least one hop based on the comparison of the determined carbon intensity with the carbon threshold.

In several more embodiments, the energy score is a function of the assigned location factor, the assigned energy source factor, and the assigned carbon factor.

In numerous embodiments, a device may include a processor, a network interface controller configured to provide access to a network, and a memory communicatively coupled to the processor. The memory comprises a network management logic that is configured to identify, in the network, a plurality of network paths. Each network path of the plurality of network paths comprises at least one hop. The network management logic is further configured to determine an energy score of each network path based on a set of energy parameters associated with the at least one hop and one or more weights associated with the set of energy parameters. Further, the network management logic is configured to select one of the plurality of network paths based on the energy score of each network path and route traffic along the selected network path.

In numerous additional embodiments, a method may include identifying, in a network, at least one network path comprising one or more hops and determining a set of energy parameters associated with at least one hop of the one or more hops. The method may further include assigning one or more weights to the determined set of energy parameters and determining an energy score of the at least one network path based on the determined set of energy parameters and the assigned one or more weights.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example networking environment employing energy scoring of network paths in accordance with various embodiments of the disclosure;

FIG. 2 is a conceptual illustration of an energy score determination operation in accordance with various embodiments of the disclosure;

FIG. 3 is a conceptual illustration of a factor-based energy score determination operation in accordance with various embodiments of the disclosure;

FIG. 4 is a flowchart depicting a process for determining energy scores of network paths in accordance with various embodiments of the disclosure;

FIG. 5 is a flowchart depicting a process for determining network path energy scores using identified and predicted hops in accordance with various embodiments of the disclosure;

FIG. 6 is a flowchart depicting a process for determining network path energy scores using hop filtering at each stage in accordance with various embodiments of the disclosure;

FIG. 7 is a flowchart depicting a process for determining factor-based energy scores of network paths in accordance with various embodiments of the disclosure;

FIG. 8 is a flowchart depicting a process for routing traffic in a network using energy scores of network paths in accordance with various embodiments of the disclosure; and

FIG. 9 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that may facilitate the determination of energy scores of network paths and the selection of a network path for traffic routing based on the energy scores. In a network, the amount of energy consumed by network devices and/or network operations and the source of this energy can be utilized to measure the carbon footprint of the network. This may be possible for smaller networks, such as local area networks (“LANs”), where access to energy metrics about the underlaying network devices may be available. However, these types of approaches may not be easily deployable in applications such as enterprise routing, a wide area network (“WAN”), or a software-defined wide area network (“SDWAN”), where traffic might traverse the Internet and/or operator networks where energy metrics about the underlaying network devices may not be available. Consequently, the carbon footprints of such networks can often get overlooked, which negatively impacts sustainability practices.

To solve the aforementioned issue, the present disclosure may describe a sustainability approach where an energy score can be determined for each network path within a network. In many embodiments, the network may correspond to an enterprise network, an SDWAN, a WAN, or the like. In other words, the network may correspond to large-area networks where traffic might traverse the Internet and/or operator networks where information about the underlaying network devices may not be available. In a number of embodiments, the energy score may be determined based on information obtained or predicted for various network devices in the network path and weights (e.g., an accuracy or a degree of confidence) of the information. The energy score may indicate the environmental impact of the network path. Thus, such energy scores can be utilized in routing decisions to select a network path that has a lesser environmental impact, and in turn, achieve a higher level of sustainability.

A network manager may be configured to identify, in the network, a plurality of network paths. A network path may be identified by using a network path probing technique. Each network path may include one or more hops (e.g., network devices). The one or more hops of the network path may conform to a network topology. In a variety of embodiments, the network manager may be configured to compare the network topology of the network path with a reference topology associated with the network path. The reference topology may correspond to a known arrangement of devices in the network and may be obtained from various service providers servicing the regions encompassed by the network path.

In more embodiments, a hop of the network path can be selected for energy score determination in response to a position of the hop in the network topology being within a threshold range of a position of another hop in the reference topology. Thus, from the network path, exclusively the hops whose positions can be ascertained with sufficient confidence or accuracy are considered for the energy score determination. The network manager may be configured to determine a set of energy parameters associated with each selected hop of the network path and assign one or more weights to the determined set of energy parameters. A weight may correspond to an accuracy of or a level of confidence in the determined energy parameter.

In additional embodiments, the set of energy parameters of a hop may include at least one of a geolocation or one or more energy sources associated with the hop. In further embodiments, the network manager may be configured to determine the one or more energy sources based on the geolocation. In still more embodiments, the network manager may be configured to determine the one or more energy sources by probing the corresponding hop. The one or more weights may similarly include at least one of a location weight or an energy source weight. The location weight may be assigned to the determined geolocation and the energy source weight may be assigned to the determined one or more energy sources. In still further embodiments, the energy source weight may be assigned based on how the energy sources are determined for a hop. The location weight may similarly be assigned based on the confidence or accuracy of the geolocation determination.

The network manager may be configured to determine an energy score of the network path based on the determined set of energy parameters and the assigned one or more weights associated with each selected hop of the network path. In still additional embodiments, determining the energy score may include comparing the assigned one or more weights with a weight threshold and determining a carbon intensity of the hop based on the set of energy parameters in response to at least one weight being greater than the weight threshold. The weight threshold may correspond to a minimum acceptable weight for a hop to be considered for carbon intensity determination.

In examples where the set of energy parameters may include both the geolocation and the one or more energy sources, the network manager may determine the one or more energy sources of a hop exclusively when the location weight of the hop is greater than a location threshold. Similarly, the network manager may determine the carbon intensity of the hop based on the one or more energy sources exclusively when the energy source weight of the hop is greater than an energy source threshold. The location threshold may correspond to a minimum acceptable location weight for a hop to be considered for energy source determination. Similarly, the energy source threshold may correspond to a minimum acceptable energy source weight for a hop to be considered for carbon intensity determination.

The energy score of the network path can thus be determined based on the carbon intensities of hops having weights (e.g., the location and energy source weights) greater than the weight threshold (e.g., the location and energy source thresholds). The carbon intensity of a hop may be a function of the types of energy sources that power the hop. The carbon intensity can thus be a measure of the environmental impact of a hop. In an example, a higher carbon intensity may be configured to indicate low carbon energy emissions and thus lower environmental impact.

In some more embodiments, to determine the energy score of the network path, the network manager may be configured to determine (e.g., predict) presence of one or more additional hops in the network path along with the identified hops. For example, the network manager may determine presence of unexposed hops in the network path along with the exposed hops. In such a scenario, the energy score may be further determined based on the one or more additional hops. The utilization of the additional hops for the energy score determination may ensure that otherwise invisible carbon costs from the Open Systems Interconnection (“OSI”) model layer-1, layer-2, and layer-3 hops can be considered for the routing decisions.

In yet more embodiments, the energy score may be configured to indicate a number of hops of the network path that have carbon intensities greater than a carbon threshold. The carbon threshold may correspond to a minimum acceptable carbon intensity for a hop to be considered to have a low environmental impact. Thus, a hop having a carbon intensity greater than the carbon threshold may be configured to indicate that the environmental impact of the hop is less. In an example, the network path may have a total of six hops whose positions in the network topology are within the threshold range of six other hops in the reference topology. The six hops may be identified hops, predicted hops, or a combination thereof. Further, among the six hops, four hops have weights greater than the weight threshold, and three among the four may have carbon intensities greater than the carbon threshold. In such a scenario, the energy score of the network path may be 0.5 (e.g., 3÷6). In an example, the higher the energy score, the lower the environmental impact. The energy score of the remaining network paths may be determined in a manner that is similar to the energy score determination described above.

In still yet more embodiments, the network manager may be configured to select one network path based on the energy scores of all the network paths. In an example, the network manager may select a network path having the highest energy score. Thus, in the present disclosure, the energy score is utilized to identify a network path with more probability of using less carbon. In other words, the present disclosure may describe a methodology to determine if a network path could be considered “greener or lower carbon” than alternate network paths. The network manager may be configured to route traffic along the selected network path.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (“PCB”) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board, or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

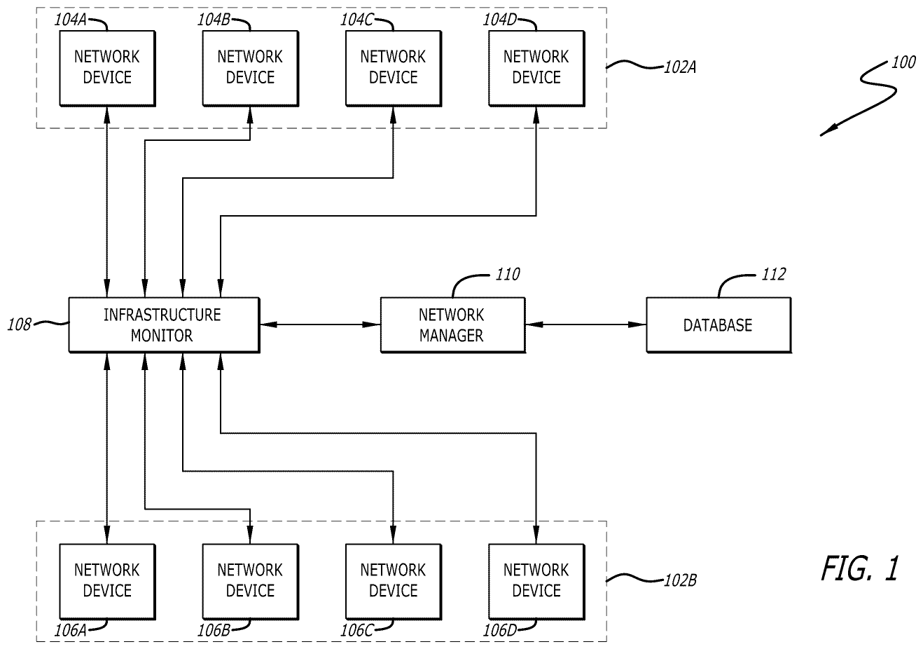

Referring to FIG. 1, a schematic block diagram of an example networking environment 100 employing energy scoring of network paths in accordance with various embodiments of the disclosure is shown. The networking environment 100 may correspond to a network. A network can be, for example, an interconnected system that enables communication and data exchange between multiple devices.

The embodiments depicted in FIG. 1 may show the networking environment 100 including one or more network paths, for example, network paths 102A and 102B. A network path may refer to a route that data packets take to travel from a source to a destination. In many embodiments, the network paths 102A and 102B may be associated with the same source and destination pair. The source and destination may be located in different cities, countries, continents, or the like. A network path may thus encompass numerous towns, cities, countries, continents, or the like. In FIG. 1, the networking environment 100 is shown to include two network paths to keep the illustration concise and clear, and should not be considered a limitation of the present disclosure. A network can include any number of network paths between the source and destination pair.

Each network path may include one or more network devices (also referred to as “hops”). For example, the network path 102A may include a first set of network devices, of which network devices 104A-104D are shown. Similarly, the network path 102B may include a second set of network devices, of which network devices 106A-106D are shown. A network device may include hardware and/or software components that can facilitate data communication and transmission between computers or other network-enabled devices. Examples of the network device may include a router, a switch, a hub, a modem, an access point, a server, a computing node, or the like. In FIG. 1, a network path is shown to include four network devices to keep the illustration concise and clear and should not be considered a limitation of the present disclosure. A network path may include any number of network devices. Further, the network paths may include a different number of network devices.

In a network, the amount of energy consumed by network devices and/or network operations and the source of this energy can be utilized to measure the carbon footprint of the network. This may be possible for smaller networks, such as local area networks (“LANs”), where access to energy metrics about the underlaying network devices may be available. However, these types of approaches may not be easily deployable in applications such as enterprise routing, a wide area network (“WAN”), or a software-defined wide area network (“SDWAN”), where traffic might traverse the Internet and/or operator networks where energy metrics about the underlaying network devices may not be available. Consequently, the carbon footprints of such networks can often get overlooked, which negatively impacts sustainability practices.

To solve the aforementioned issue, the present disclosure may describe a sustainability approach where an energy score is determined for each network path within a network (such as the networking environment 100). In a number of embodiments, the networking environment 100 may correspond to an enterprise network, an SDWAN, a WAN, or the like. In other words, the networking environment 100 may correspond to large-area networks where traffic might traverse the Internet and/or operator networks where information about the underlaying network devices may not be available. In a variety of embodiments, the energy score may be determined based on information obtained or predicted for various network devices in a network path and weights (e.g., an accuracy or a degree of confidence) of the information. The energy score may indicate the environmental impact of the corresponding network path. Thus, such energy scores can be utilized in routing decisions to select a network path that has a lesser environmental impact, and in turn, achieve a higher level of sustainability.

To enable the sustainability approach of the present disclosure, the networking environment 100 may include an infrastructure monitor 108 and a network manager 110. The infrastructure monitor 108 may be coupled to various network devices (e.g., the network devices 104A-104D and 106A-106D) of the network, and may be configured to monitor and/or control the network devices. For example, the infrastructure monitor 108 may be configured to route traffic through a selected network path to control the carbon footprint of the network. This may ensure that the network adheres to the sustainability objectives.

The network manager 110 may include suitable circuitry that may be configured to perform one or more operations. For example, the network manager 110 may be configured to identify, in the network, a plurality of network paths (e.g., the network paths 102A and 102B). A network path may be identified by using a network path probing technique. Each network path may include one or more hops (e.g., network devices). The one or more hops (e.g., the network devices 104A-104D) of the network path 102A may conform to a network topology. A network topology may refer to an arrangement of devices in a network and may define how different devices can communicate with each other. In additional embodiments, the network manager 110 may be configured to compare the network topology of the network path 102A with a reference topology associated with the network path 102A. The reference topology may be obtained from various service providers servicing the regions (e.g., towns, cities, countries, continents, or the like) encompassed by the network path 102A. The reference topology may refer to a known arrangement of network devices in the regions encompassed by the network path 102A. In further embodiments, the networking environment 100 may include a database 112 that may be configured to store the reference topologies of various network paths of the networking environment 100. The network manager 110 may be configured to access the database 112 to retrieve the reference topology associated with the network path 102A prior to the comparison.

In still more embodiments, a network device of the network path is selected for energy score determination in response to the network device (e.g., the hop) in the network topology being within a threshold range of another network device (e.g., the hop) in the reference topology. For example, a network device is selected for energy score determination when a position of the network device in the network topology is within a threshold range of a position of another network device in the reference topology. In still further embodiments, two hops may be considered to be within the threshold range of each other if they are positioned within a geographical region (e.g., a 5-mile radius). Thus, from the network path 102A, exclusively the hops whose positions can be ascertained with sufficient confidence or accuracy are considered for the energy score determination.

The network manager 110 may be configured to determine a set of energy parameters associated with each selected hop of the network path 102A. The set of energy parameters associated with a hop may thus be determined in response to the hop in the network topology being within the threshold range of another hop in the reference topology. The network manager 110 may be configured to assign one or more weights to the determined set of energy parameters associated with each selected hop of the network path 102A. A weight may correspond to an accuracy of or a level of confidence in the determined energy parameter.

In still additional embodiments, the set of energy parameters of a hop may include at least one of a geolocation or one or more energy sources associated with the hop. In an example, the geolocation of a hop may be determined using various systems such as ThousandEyes®, Skylight™, or the like. In some more embodiments, the network manager 110 may be configured to determine the one or more energy sources based on the geolocation. The database 112 may be configured to store the energy information for various geographical regions across the globe. In an example, the energy information may include information obtained directly from power companies, International Energy Agency information, third-party service (e.g., www.electricitymaps.com) non-estimated energy information, and third-party service estimated information. The network manager 110 may be configured to access the database 112 to determine the one or more energy sources associated with the geolocation. In yet more embodiments, the network manager 110 may be configured to determine the one or more energy sources by probing the corresponding hop.

The one or more weights may similarly include at least one of a location weight or an energy source weight. In response to the set of energy parameters comprising the geolocation, the one or more weights may include a location weight assigned to the geolocation. Similarly, in response to the set of energy parameters comprising the one or more energy sources, the one or more weights may include an energy source weight assigned to the one or more energy sources. In still yet more embodiments, the energy source weight may be assigned based on how the energy sources are determined for a hop. In an example, the energy source weight may be ‘very high’, if the energy sources are determined based on the information directly obtained from power companies. The energy source weight may be ‘high’, if the energy sources are determined based on the International Energy Agency information. Similarly, the energy source weight may be ‘medium’ and ‘low’, if the energy sources are determined based on the third-party service non-estimated and estimated information, respectively. The location weight may similarly be assigned based on the confidence or accuracy of the geolocation determination.

The network manager 110 may be configured to determine an energy score of the network path 102A based on the determined set of energy parameters and the assigned one or more weights associated with each selected hop of the network path 102A. In many further embodiments, determining the energy score based on the determined set of energy parameters and the assigned one or more weights may include comparing the assigned one or more weights with a weight threshold. Determining the energy score may further include determining a carbon intensity of the hop based on the determined set of energy parameters in response to at least one of the assigned one or more weights being greater than the weight threshold. The weight threshold may correspond to a minimum acceptable weight for a hop to be considered for carbon intensity determination. Thus, at least one of the assigned one or more weights being greater than the weight threshold triggers the network manager 110 to determine the carbon intensity of the hop. In other words, the carbon intensity of a hop is determined exclusively when one of the assigned weights is greater than the weight threshold.

In examples where the set of energy parameters includes both the geolocation and the one or more energy sources, the network manager 110 may determine the one or more energy sources of a hop exclusively when the location weight of the hop is greater than a location threshold. In other words, the location weight of the hop being greater than the location threshold triggers the network manager 110 to determine the one or more energy sources of the hop. Similarly, the network manager 110 may determine the carbon intensity of the hop based on the one or more energy sources exclusively when the energy source weight of the hop is greater than an energy source threshold. In other words, the energy source weight of the hop being greater than the energy source threshold triggers the network manager 110 to determine the carbon intensity of the hop. The location threshold may correspond to a minimum acceptable location weight for a hop to be considered for energy source determination. Similarly, the energy source threshold may correspond to a minimum acceptable energy source weight for a hop to be considered for carbon intensity determination. In an example, the energy source threshold may correspond to ‘low’.

The energy score of the network path 102A is thus determined based on the carbon intensities of hops having weights (e.g., the location and energy source weights) greater than the weight threshold (e.g., the location and energy source thresholds). The carbon intensity of a hop may be a function of the types of energy sources that power the hop. The carbon intensity can thus be a measure of the environmental impact of a hop. In an example, a higher carbon intensity may be configured to indicate low carbon energy emissions and thus lower environmental impact.

In many additional embodiments, to determine the energy score of the network path 102A, the network manager 110 may be configured to determine (e.g., predict) presence of one or more additional hops in the network path 102A along with the identified hops. For example, the network manager 110 may determine presence of unexposed hops in the network path 102A along with the exposed hops. In such a scenario, the energy score may be further determined based on the one or more additional hops. In other words, energy parameters may be determined for each additional hop and weights may be assigned to the energy parameters. Further, the energy parameters and the weights of the one or more additional hops may be utilized for determining the energy score of the network path 102A in a similar manner as described above. The utilization of the additional hops for the energy score determination ensures that otherwise invisible carbon costs from the Open Systems Interconnection (“OSI”) model layer-1 hops, the OSI model layer-2 hops, and the OSI model layer-3 hops are considered for the routing decisions.

In still yet further embodiments, the energy score may be configured to indicate a number of hops of the network path 102A that have carbon intensities greater than a carbon threshold. The carbon threshold may correspond to a minimum acceptable carbon intensity for a hop to be considered to have a low environmental impact. Thus, a hop having a carbon intensity greater than the carbon threshold may be configured to indicate that the environmental impact of the hop is less. In an example, the network path 102A may have a total of six hops whose positions in the network topology are within the threshold range of six other hops in the reference topology. The six hops may be identified hops, predicted hops, or a combination thereof. Further, among the six hops, four hops have weights greater than the weight threshold, and three among the four may have carbon intensities greater than the carbon threshold. In such a scenario, the energy score of the network path 102A may be 0.5 (e.g., 3÷6). In an example, the higher the energy score, the lower the environmental impact. The energy score of the network path 102B may be determined in a manner that is similar to the energy score determination of the network path 102A.

In still yet additional embodiments, the network manager 110 may be configured to select one of the network paths 102A and 102B based on the energy score of each of the network paths 102A and 102B. In an example, the network manager 110 may select a network path having the highest energy score. Thus, in the present disclosure, the energy score is utilized to identify a network path with more probability of using less carbon. In other words, the present disclosure may describe a methodology to determine if a network path could be considered “greener or lower carbon” than alternate network paths. In some cases, this classification may be independent of the actual watts of power consumed. The network manager 110 may be configured to route traffic along the selected network path. In several embodiments, the network manager 110 may route traffic along the selected network path by way of the infrastructure monitor 108.

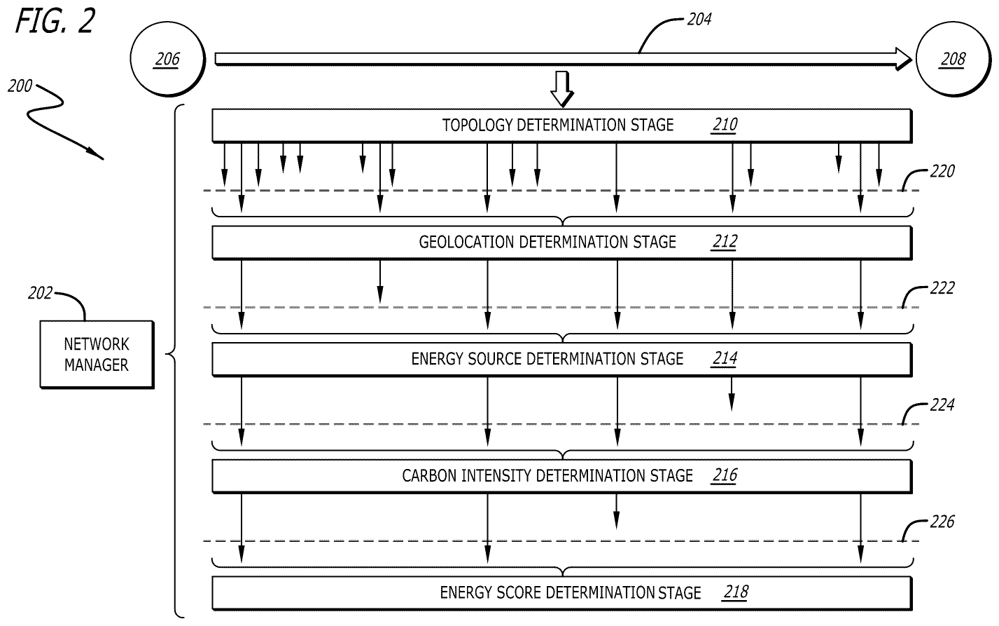

Although a specific embodiment for a networking environment 100 suitable for carrying out the various steps, processes, methods, and operations described herein is discussed with respect to FIG. 1, any of a variety of systems and/or processes may be utilized in accordance with embodiments of the disclosure. For example, the network manager 110 may be included in the infrastructure monitor 108. In several more embodiments, the network manager 110 may be included in one of the network devices 104A-104D and 106A-106D. The elements depicted in FIG. 1 may also be interchangeable with other elements of FIGS. 2-9 as required to realize a particularly desired embodiment.

Referring to FIG. 2, a conceptual illustration of an energy score determination operation 200 in accordance with various embodiments of the disclosure is shown. The embodiments depicted in FIG. 2 may show the energy score determination operation 200 that may be performed by a network manager 202. The energy score determination operation 200 may include the determination of an energy score of a network path 204 between a source 206 and a destination 208. In many embodiments, the source 206 and the destination 208 may be network devices. The network path 204 may refer to a route that data packets take to travel from the source 206 to the destination 208. In a number of embodiments, the energy score determination operation 200 may include various stages, for example, a topology determination stage 210, a geolocation determination stage 212, an energy source determination stage 214, a carbon intensity determination stage 216, and an energy score determination stage 218.

At the topology determination stage 210, the network manager 202 may be configured to identify, in a network, the network path 204. The network path 204 may include a plurality of hops. In a variety of embodiments, the network manager 202 may be configured to determine (e.g., predict) presence of one or more additional hops in the network path 204. In more embodiments, the additional hops may correspond to the OSI model layer-1 hops, the OSI model layer-2 hops, the OSI model layer-3 hops, or a combination thereof. All the hops (e.g., the identified and predicted hops) of the network path 204 may conform to a network topology. The network manager 202 may be configured to compare the network topology of the network path 204 with a reference topology associated with the network path 204. The reference topology may be a known arrangement of devices obtained from various service providers servicing the regions encompassed by the network path 204. The comparison of the network topology with the reference topology may result in indicating how close a hop of the network path 204 is with another hop in the reference topology. This closeness can be defined as a position nearness value and may be indicative of the accuracy of the identified or predicted position of the hop.

A position nearness value of each hop of the network path 204 is illustrated in FIG. 2 by way of arrows extending out from the topology determination stage 210. In additional embodiments, the network manager 202 may be configured to select exclusively those hops that have the position nearness values greater than a position threshold 220. The position threshold 220 may be indicative of a minimum acceptable position nearness value for considering a hop for subsequent stages. In other words, a hop is considered for the energy score determination when the position of the hop in the network topology is within a threshold range of a position of another hop in the reference topology. Thus, from the network path 204, exclusively the hops whose positions can be ascertained with sufficient confidence or accuracy are considered for the subsequent stages. As illustrated in FIG. 2, six hops are selected based on their position nearness values being greater than the position threshold 220. In further embodiments, the energy score of the network path 204 can be determined based on energy metrics associated with these six hops. In numerous additional embodiments, the source 206 may be located in Barcelona, the destination 208 may be located in Helsinki, and the six hops may be located in Paris, Lille, Brussels, Amsterdam, Copenhagen, and Stockholm.

At the geolocation determination stage 212, the network manager 202 may be configured to determine the geolocations of the six hops. Thus, the position nearness values of the six hops being greater than the position threshold 220 triggers the network manager 202 to determine the geolocations of the six hops. In still more embodiments, the geolocation of a hop may be determined using various systems such as ThousandEyes®, Skylight™, or the like. The network manager 202 may be configured to assign a location weight to the determined geolocation of each hop. In still further embodiments, the location weight is assigned based on the confidence or accuracy of the geolocation determination. For example, the location weight is higher if the geolocation can be narrowed down to a city with sufficient confidence or accuracy. The location weights of the six hops are illustrated in FIG. 2 by way of six arrows extending out from the geolocation determination stage 212. In still additional embodiments, the network manager 202 may be configured to compare the location weight of each of the six hops with a location threshold 222. The location threshold 222 may be indicative of a minimum acceptable location weight for considering a hop for subsequent stages. Thus, the network manager 202 may be configured to select exclusively those hops for subsequent stages that have the location weights greater than the location threshold 222. Hence, from the network path 204, exclusively the hops whose geolocations can be ascertained with sufficient confidence or accuracy are considered for the subsequent stages. As illustrated in FIG. 2, five hops are selected.

At the energy source determination stage 214, the network manager 202 may be configured to determine the one or more energy sources associated with each of the five hops. In some more embodiments, the one or more energy sources may be determined based on the geolocation. The one or more energy sources associated with a hop may be determined in response to the location weight of the associated geolocation being greater than the location threshold 222. Thus, the location weights of the five hops being greater than the location threshold 222 triggers the network manager 202 to determine the one or more energy sources associated with each of the five hops. The network manager 202 may be configured to assign an energy source weight to the determined one or more energy sources of each hop. In yet more embodiments, the energy source weight may be assigned based on how the energy sources are determined for a hop (e.g., based on the confidence or accuracy of the energy source determination). For example, the energy source weight is higher if the energy source information is obtained from known reliable avenues (e.g., power companies, International Energy Agency, or the like).

The energy source weights of the five hops are illustrated in FIG. 2 by way of five arrows extending out from the energy source determination stage 214. In still yet more embodiments, the network manager 202 may be configured to compare the energy source weight of each of the five hops with an energy source threshold 224. The energy source threshold 224 may be indicative of a minimum acceptable energy source weight for considering a hop for subsequent stages. Thus, the network manager 202 may be configured to select exclusively those hops for subsequent stages that have the energy source weights greater than the energy source threshold 224. Hence, from the network path 204, exclusively the hops whose energy sources can be ascertained with sufficient confidence or accuracy are considered for the subsequent stages. As illustrated in FIG. 2, four hops are selected.

At the carbon intensity determination stage 216, the network manager 202 may be configured to determine the carbon intensity associated with each of the four hops. The carbon intensity associated with a hop may thus be determined in response to the energy source weight of the associated one or more energy sources being greater than the energy source threshold 224. Thus, the energy source weights of the four hops being greater than the energy source threshold 224 triggers the network manager 202 to determine the carbon intensity associated with each of the four hops. In many further embodiments, the carbon intensity may be determined based on the one or more energy sources. More specifically, the carbon intensity may be determined based on the types of the one or more energy sources. The carbon intensities of the four hops are illustrated in FIG. 2 by way of four arrows extending out from the carbon intensity determination stage 216. In many additional embodiments, the network manager 202 may be configured to compare the carbon intensity of each of the four hops with a carbon threshold 226. The carbon threshold 226 may be indicative of a minimum acceptable carbon intensity for a hop to be considered to have a low environmental impact. As illustrated in FIG. 2, three hops have carbon intensities greater than the carbon threshold 226.

At the energy score determination stage 218, the network manager 202 may be configured to determine the energy score of the network path 204. In still yet further embodiments, the energy score may be configured to indicate a number of hops of the network path 204 that have carbon intensities greater than the carbon threshold 226. As the network path 204 has a total of six hops considered for energy score determination and three of those hops have carbon intensities greater than the carbon threshold 226, the energy score of the network path 204 may be 0.5 (e.g., 3÷6). Thus, the carbon intensities of the three hops being greater than the carbon threshold 226 triggers the network manager 202 to select these three hops for the energy score determination. In still yet additional embodiments, the network manager 202 may be configured to route traffic along the network path 204 based on the determined energy score. In other words, the energy score may be utilized for routing decisions. In an example, the network manager 202 may route traffic along the network path 204 based on the energy score of the network path 204 being the highest among the energy scores of other network paths between the source 206 and the destination 208.

In several embodiments, the position threshold 220, the location threshold 222, the energy source threshold 224, and the carbon threshold 226 may be percentage values. In several more embodiments, the position threshold 220, the location threshold 222, the energy source threshold 224, and the carbon threshold 226 may be equal percentage values. In numerous embodiments, the position threshold 220, the location threshold 222, the energy source threshold 224, and the carbon threshold 226 may be different percentage values.

Although a specific embodiment for an energy score determination operation 200 suitable for carrying out the various steps, processes, methods, and operations described herein is discussed with respect to FIG. 2, any of a variety of systems and/or processes may be utilized in accordance with embodiments of the disclosure. For example, at each stage, hops may not be removed from the energy score determination and all hops may undergo all the stages of the energy score determination operation 200. The elements depicted in FIG. 2 may also be interchangeable with other elements of FIGS. 1 and 3-9 as required to realize a particularly desired embodiment.

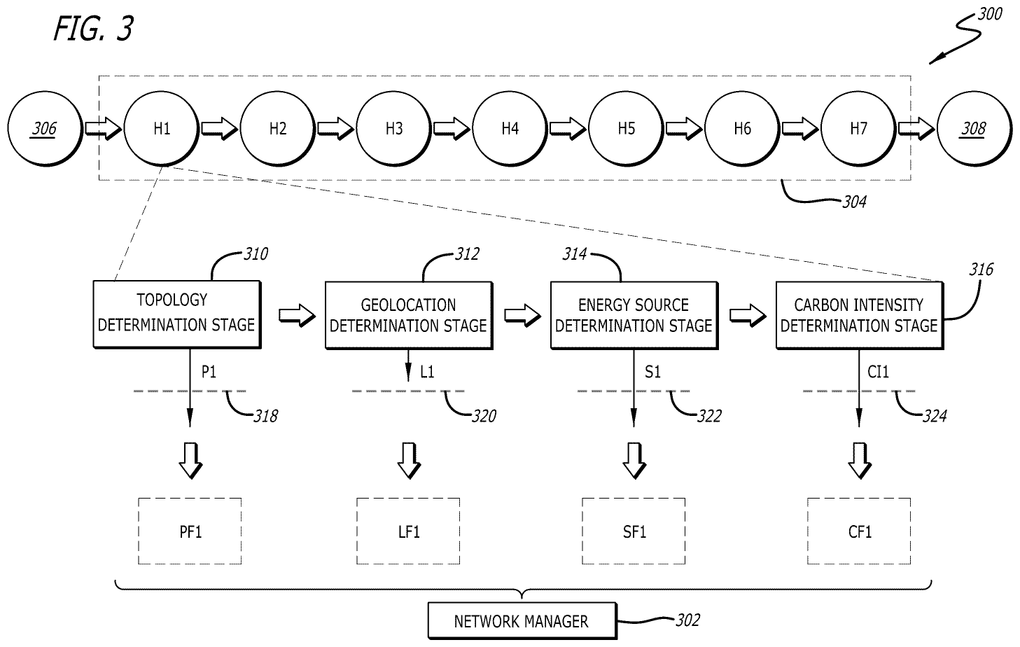

Referring to FIG. 3, a conceptual illustration of a factor-based energy score determination operation 300 in accordance with various embodiments of the disclosure is shown. The embodiments depicted in FIG. 3 may show the factor-based energy score determination operation 300 that may be performed by a network manager 302. The factor-based energy score determination operation 300 may include the determination of the energy score of a network path 304 between a source 306 and a destination 308.

In many embodiments, the network manager 302 may be configured to identify, in a network, the network path 304 including a plurality of hops. In a number of embodiments, the network manager 302 may be configured to determine (e.g., predict) presence of one or more additional hops in the network path 304. Thus, as illustrated in FIG. 3, seven hops H1-H7 may be associated with the network path 304. The seven hops H1-H7 may include the identified hops as well as the predicted hops. All the hops (e.g., the identified and predicted hops) of the network path 304 may conform to a network topology.

The factor-based energy score determination operation 300 may include various stages and each of the seven hops H1-H7 may undergo all the stages, with a factor assigned to a hop at each stage. The energy score of the network path 304 may be determined based on all the factors assigned to each hop. In FIG. 3, the factor-based energy score determination operation 300 being executed on the hop H1 is described. Similar operations may be executed on the remaining six hops H2-H7. The factor-based energy score determination operation 300 may include various stages, for example, a topology determination stage 310, a geolocation determination stage 312, an energy source determination stage 314, and a carbon intensity determination stage 316.

At the topology determination stage 310, the network manager 302 may be configured to compare the network topology of the network path 304 with a reference topology associated with the network path 304. The reference topology may be a known arrangement of network devices obtained from various service providers servicing the regions encompassed by the network path 304. In a variety of embodiments, the comparison of the network topology with the reference topology may result in indicating how close the hop H1 is with another hop in the reference topology. This closeness can be defined as a position nearness value P1 and may be indicative of the accuracy of the identified or predicted position of the hop H1. In more embodiments, the network manager 302 may be configured to compare the position nearness value P1 with a position threshold 318. Further, the network manager 302 may be configured to assign a position factor PF1 to the hop H1 based on the comparison of the position nearness value P1 with the position threshold 318. In additional embodiments, the position factor PF1 may indicate whether the position nearness value P1 is greater than the position threshold 318. In an example, the position factor PF1 may be higher if the position nearness value P1 is greater than the position threshold 318.

At the geolocation determination stage 312, the network manager 302 may be configured to determine the geolocation of the hop H1 and assign a location weight L1 to the determined geolocation. In further embodiments, the location weight may be assigned based on the confidence or accuracy of the geolocation determination. In still more embodiments, the network manager 302 may be configured to compare the location weight L1 with a location threshold 320. The network manager 302 may be configured to assign a location factor LF1 to the hop H1 based on the comparison of the location weight L1 with the location threshold 320. In still further embodiments, the location factor LF1 may indicate whether the location weight L1 is greater than the location threshold 320. In an example, the location factor LF1 may be higher if the location weight L1 is greater than the location threshold 320.

At the energy source determination stage 314, the network manager 302 may be configured to determine the one or more energy sources associated with the hop H1. In still additional embodiments, the one or more energy sources may be determined based on the geolocation of the hop H1. The network manager 302 may be configured to assign an energy source weight S1 to the determined one or more energy sources of the hop H1. In some more embodiments, the energy source weight S1 may be assigned based on how the energy sources are determined for the hop H1. In yet more embodiments, the network manager 302 may be configured to compare the energy source weight S1 with an energy source threshold 322. The network manager 302 may be configured to assign an energy source factor SF1 to the hop H1 based on the comparison of the energy source weight S1 with the energy source threshold 322. In still yet more embodiments, the energy source factor SF1 may indicate whether the energy source weight S1 is greater than the energy source threshold 322. In an example, the energy source factor SF1 may be higher if the energy source weight S1 is greater than the energy source threshold 322.

At the carbon intensity determination stage 316, the network manager 302 may be configured to determine a carbon intensity CI1 associated with the hop H1. In many further embodiments, the carbon intensity CI1 may be determined based on the one or more energy sources. More specifically, the carbon intensity CI1 may be determined based on the types of the one or more energy sources. In many additional embodiments, the network manager 302 may be configured to compare the carbon intensity CI1 with a carbon threshold 324. The network manager 302 may be configured to assign a carbon factor CF1 to the hop H1 based on the comparison of the carbon intensity CI1 with the carbon threshold 324. In still yet further embodiments, the carbon factor CF1 may indicate whether the carbon intensity CI1 is greater than the carbon threshold 324. In an example, the carbon factor CF1 may be higher if the carbon intensity CI1 is greater than the carbon threshold 324.

Based on the position factor PF1, the location factor LF1, the energy source factor SF1, and the carbon factor CF1, an energy factor may be determined for the hop H1. The energy factor may be configured to indicate the environmental impact of the hop H1. The energy factors may be similarly determined for the hops H2-H7. Based on the energy factors of the hops H1-H7, the network manager 302 may be configured to determine the energy score of the network path 304. The energy score is thus a function of the assigned position factors (e.g., the position factor PF1), the assigned location factors (e.g., the location factor LF1), the assigned energy source factors (e.g., the energy source factor SF1), and the assigned carbon factors (e.g., the carbon factor CF1).

Although a specific embodiment for a factor-based energy score determination operation 300 suitable for carrying out the various steps, processes, methods, and operations described herein is discussed with respect to FIG. 3, any of a variety of systems and/or processes may be utilized in accordance with embodiments of the disclosure. For example, each factor may additionally indicate a difference between the determined value, weight, or intensity and the corresponding threshold. The elements depicted in FIG. 3 may also be interchangeable with other elements of FIGS. 1, 2, and 4-9 as required to realize a particularly desired embodiment.

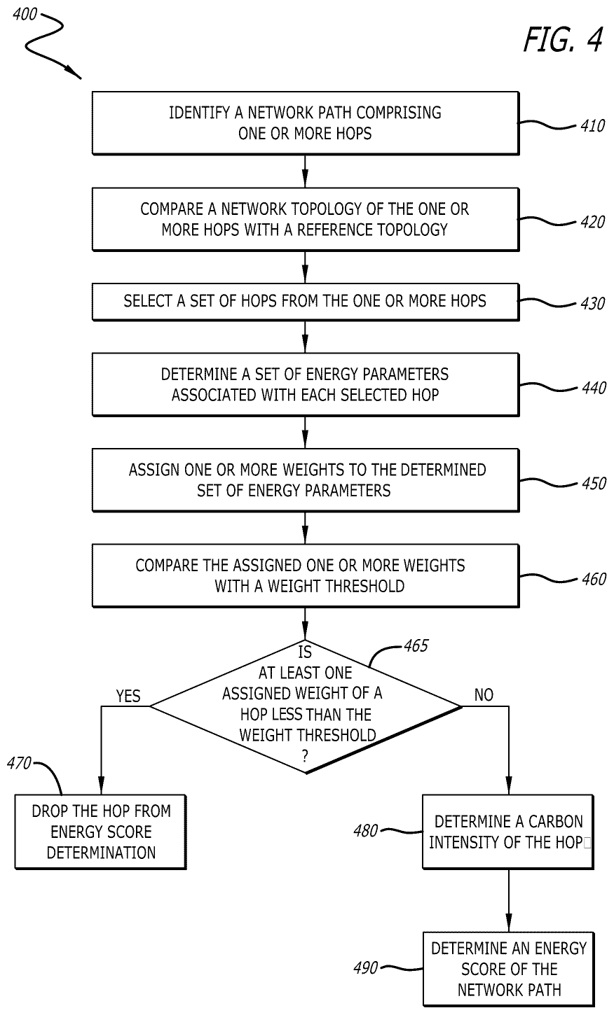

Referring to FIG. 4, a process 400 for determining energy scores of network paths in accordance with various embodiments of the disclosure is shown. In many embodiments, the process 400 may identify a network path comprising one or more hops (block 410). A network path may be identified by using a network path probing technique. In an example, the network path probing technique may include the transmission of one or more probe packets in the network. These probe packets may be modified by various network devices of the network to include network information. The modified probe packets can be utilized to identify the network path. The one or more hops of the network path may conform to a network topology.

In a number of embodiments, the process 400 may compare a network topology of the one or more hops with a reference topology (block 420). The reference topology may be obtained from various service providers servicing the regions encompassed by the network path. The comparison of the network topology with the reference topology may result in indicating how close a hop of the network path is with another hop in the reference topology. This closeness can be defined as a position nearness value and may be indicative of the accuracy of the identified position of the hop.

In a variety of embodiments, the process 400 may select a set of hops from the one or more hops (block 430). A hop of the network path is selected for energy score determination in response to the hop in the network topology being within a threshold range of another hop in the reference topology. In more embodiments, two hops may be considered to be within the threshold range of each other if they are positioned within a geographical region (e.g., a 5-mile radius). Thus, the set of hops may correspond to hops whose positions can be ascertained with sufficient confidence or accuracy.

In additional embodiments, the process 400 may determine a set of energy parameters associated with each selected hop (block 440). In further embodiments, the set of energy parameters of a hop may include at least one of a geolocation or one or more energy sources associated with the hop. In still more embodiments, the geolocation of a hop may be determined using various systems such as ThousandEyes®, Skylight™, or the like. In still further embodiments, the one or more energy sources may be determined based on the geolocation. In still additional embodiments, the one or more energy sources are determined by probing the corresponding hop using probe packets.

In some more embodiments, the process 400 may assign one or more weights to the determined set of energy parameters (block 450). A weight may correspond to an accuracy of or a level of confidence in the determined set of energy parameters. The one or more weights may similarly include at least one of a location weight or an energy source weight. The location weight may be assigned to the determined geolocation and the energy source weight may be assigned to the determined one or more energy sources. In yet more embodiments, the energy source weight may be assigned based on how the energy sources are determined for a hop. The location weight may similarly be assigned based on the confidence or accuracy of the geolocation determination.

In still yet more embodiments, the process 400 may compare the assigned one or more weights with a weight threshold (block 460). The weight threshold may correspond to a minimum acceptable weight for a hop to be considered for subsequent stages. Thus, the comparison of the assigned one or more weights with the weight threshold may enable the filtering of hops.

In several embodiments, the process 400 may determine whether at least one assigned weight of a hop is less than the weight threshold (block 465). This determination may be performed for each selected hop. In several more embodiments, in response to the at least one assigned weight of a hop being less than the weight threshold, the process 400 may drop the hop from energy score determination (block 470). Thus, all the hops whose assigned weights are less than or equal to the weight threshold may be filtered.

However, in many further embodiments, in response to the one or more assigned weights of a hop being greater than the weight threshold, the process 400 may determine a carbon intensity of the hop (block 480). Thus, carbon intensities may be determined for all hops having the one or more assigned weights greater than the weight threshold. The carbon intensity of a hop may be determined based on the set of energy parameters of the hop. In many additional embodiments, the carbon intensity of a hop may be determined based on the one or more energy sources associated with the hop. More specifically, the carbon intensity may be determined based on the types of the one or more energy sources.

In still yet further embodiments, the process 400 may determine an energy score of the network path (block 490). The energy score may be determined based on the carbon intensities of all hops having at least one assigned weight greater than the weight threshold. In still yet additional embodiments, the energy score may be configured to indicate a number of hops of the network path that have carbon intensities greater than a carbon threshold. The carbon threshold may be indicative of a minimum acceptable carbon intensity for a hop to be considered to have a low environmental impact. The energy score of the network path may be utilized for selecting the network path for traffic routing.

Although a specific embodiment for determining energy scores of network paths for carrying out the various steps, processes, methods, and operations described herein is discussed with respect to FIG. 4, any of a variety of systems and/or processes may be utilized in accordance with embodiments of the disclosure. For example, additional unexposed hops may also be utilized for the energy score determination. The elements depicted in FIG. 4 may also be interchangeable with other elements of FIGS. 1-3 and 5-9 as required to realize a particularly desired embodiment.

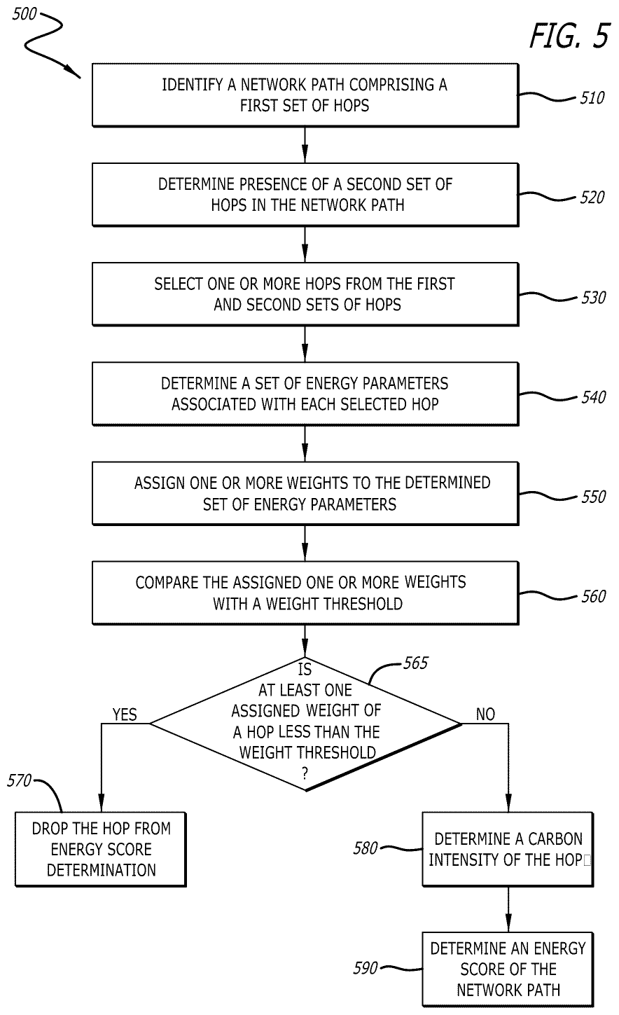

Referring to FIG. 5, a process 500 for determining network path energy scores using identified and predicted hops in accordance with various embodiments of the disclosure is shown. In many embodiments, the process 500 may identify a network path comprising a first set of hops (block 510). A network path may be identified by using a network path probing technique.

In more embodiments, the process 500 may determine (e.g., predict) presence of a second set of hops in the network path (block 520). The second set of hops may correspond to unexposed hops in the network path. The first and second sets of hops may conform to a network topology. A network topology may refer to an arrangement of devices in a network and may define how different devices can communicate with each other.

In a number of embodiments, the process 500 may select one or more hops from the first and second sets of hops (block 530). In a variety of embodiments, the network topology of the first and second sets of hops may be compared with a reference topology. The reference topology may be obtained from various service providers servicing the regions encompassed by the network path. The comparison of the network topology with the reference topology may result in indicating how close a hop of the network path is with another hop in the reference topology. This closeness can be defined as a position nearness value and may be indicative of the accuracy of the identified or predicted position of the hop. A hop of the network path is selected for energy score determination in response to the hop in the network topology being within a threshold range of another hop in the reference topology. Thus, the set of hops may correspond to hops whose positions can be ascertained with sufficient confidence or accuracy.

In additional embodiments, the process 500 may determine a set of energy parameters associated with each selected hop (block 540). In further embodiments, the set of energy parameters of a hop may include at least one of a geolocation or one or more energy sources associated with the hop. In still more embodiments, the geolocation of a hop may be determined using various systems such as ThousandEyes®, Skylight™, or the like. In still further embodiments, the one or more energy sources may be determined based on the geolocation. In still additional embodiments, the one or more energy sources are determined by probing the corresponding hop using probe packets.

In some more embodiments, the process 500 may assign one or more weights to the determined set of energy parameters (block 550). A weight may correspond to an accuracy of or a level of confidence in the determined set of energy parameters. The one or more weights may similarly include at least one of a location weight or an energy source weight. The location weight may be assigned to the determined geolocation and the energy source weight may be assigned to the determined one or more energy sources. In yet more embodiments, the energy source weight may be assigned based on how the energy sources are determined for a hop. The location weight may similarly be assigned based on the confidence or accuracy of the geolocation determination.

In still yet more embodiments, the process 500 may compare the assigned one or more weights with a weight threshold (block 560). The weight threshold may correspond to a minimum acceptable weight for a hop to be considered for subsequent stages. Thus, the comparison of the assigned one or more weights with the weight threshold may enable the filtering of hops.

In several embodiments, the process 500 may determine whether at least one assigned weight of a hop is less than the weight threshold (block 565). This determination may be performed for each selected hop. In several more embodiments, in response to the at least assigned weight of a hop being less than the weight threshold, the process 500 may drop the hop from energy score determination (block 570). Thus, all the hops whose assigned weights are less than or equal to the weight threshold may be filtered.

However, in many further embodiments, in response to the one or more assigned weights of a hop being greater than the weight threshold, the process 500 may determine a carbon intensity of the hop (block 580). Thus, carbon intensities may be determined for all hops having the one or more assigned weights greater than the weight threshold. The carbon intensity of a hop may be determined based on the set of energy parameters of the hop. In many additional embodiments, the carbon intensity of a hop may be determined based on the one or more energy sources associated with the hop. More specifically, the carbon intensity may be determined based on the types of the one or more energy sources.

In still yet further embodiments, the process 500 may determine an energy score of the network path (block 590). The energy score may be determined based on the carbon intensities of all hops having at least one assigned weight greater than the weight threshold. In still yet additional embodiments, the energy score may be configured to indicate a number of hops of the network path that have carbon intensities greater than a carbon threshold. The carbon threshold may be indicative of a minimum acceptable carbon intensity for a hop to be considered to have a low environmental impact. The energy score of the network path may be utilized for selecting the network path for traffic routing.

Although a specific embodiment for determining network path energy scores using identified and predicted hops for carrying out the various steps, processes, methods, and operations described herein is discussed with respect to FIG. 5, any of a variety of systems and/or processes may be utilized in accordance with embodiments of the disclosure. For example, the energy score of each remaining network path between the same source and destination pair can be determined in a similar manner as described above. The elements depicted in FIG. 5 may also be interchangeable with other elements of FIGS. 1-4 and 6-9 as required to realize a particularly desired embodiment.

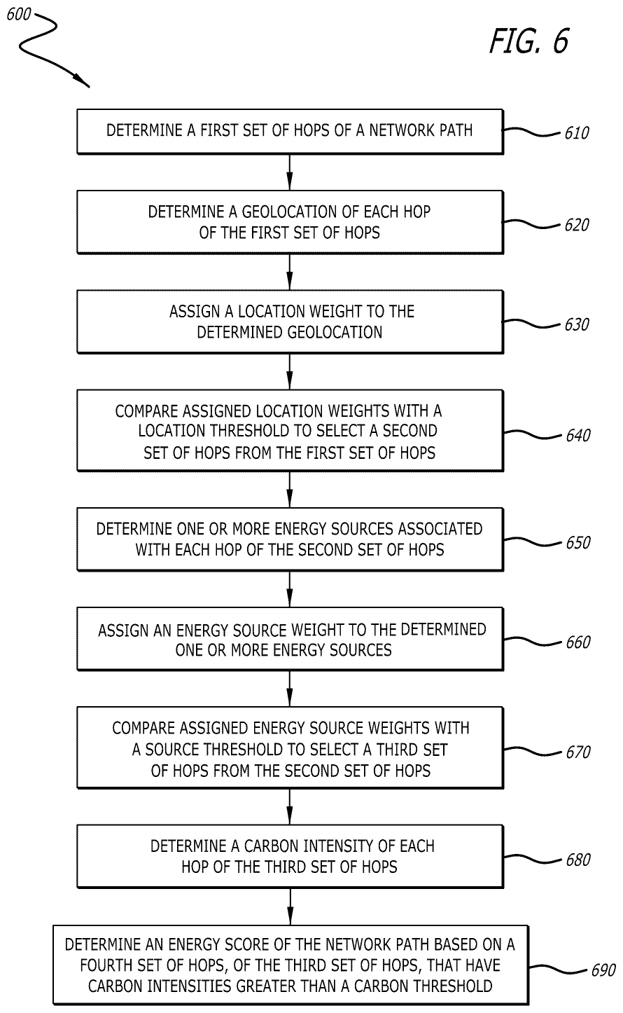

Referring to FIG. 6, a process 600 for determining network path energy scores using hop filtering at each stage in accordance with various embodiments of the disclosure is shown. In many embodiments, the process 600 may determine a first set of hops of a network path (block 610). The network path refers to the routes that data packets travel from a source to a destination. The first set of hops may include hops that are within a threshold range of at least one hop of a reference topology associated with the network path. The first set of hops may include hops identified in the network path as well as additional predicted hops.

In a number of embodiments, the process 600 may determine a geolocation of each hop of the first set of hops (block 620). In a variety of embodiments, the geolocation of a hop may be determined using various systems such as ThousandEyes®, Skylight™, or the like. The geolocation of a hop may be utilized to obtain energy source information of the hop.

In more embodiments, the process 600 may assign a location weight to the determined geolocation (block 630). In additional embodiments, the location weight may be assigned based on the confidence or accuracy of the geolocation determination. For example, the location weight may be higher if the geolocation can be narrowed down to a city with sufficient confidence or accuracy.

In further embodiments, the process 600 may compare assigned location weights with a location threshold to select a second set of hops from the first set of hops (block 640). The location threshold may be indicative of a minimum acceptable location weight for considering a hop for subsequent stages. Thus, exclusively those hops may be selected for subsequent stages whose geolocations can be ascertained with sufficient confidence or accuracy.

In still more embodiments, the process 600 may determine one or more energy sources associated with each hop of the second set of hops (block 650). In still further embodiments, the one or more energy sources may be determined based on information obtained directly from power companies, International Energy Agency information, third-party service (e.g., www.electricitymaps.com) non-estimated energy information, and third-party service estimated information. In still additional embodiments, the one or more energy sources may be determined by probing the corresponding hop.

In some more embodiments, the process 600 may assign an energy source weight to the determined one or more energy sources (block 660). In yet more embodiments, the energy source weight may be assigned based on how the energy sources are determined for a hop. For example, the energy source weight may be ‘very high’, if the energy sources are determined based on the information directly obtained from power companies. The energy source weight may be ‘high’, if the energy sources are determined based on the International Energy Agency information. Similarly, the energy source weight may be ‘medium’ and ‘low’, if the energy sources are determined based on the third-party service non-estimated and estimated information, respectively.

In still yet more embodiments, the process 600 may compare assigned energy source weights with an energy source threshold to select a third set of hops from the second set of hops (block 670). The energy source threshold may be indicative of a minimum acceptable energy source weight for considering a hop for subsequent stages. Thus, exclusively the hops whose energy sources can be ascertained with sufficient confidence or accuracy are considered for the subsequent stages.

In many further embodiments, the process 600 may determine a carbon intensity of each hop of the third set of hops (block 680). In many additional embodiments, the carbon intensity may be determined based on the one or more energy sources. More specifically, the carbon intensity may be determined based on the types of the one or more energy sources.

In still yet further embodiments, the process 600 may determine an energy score of the network path based on a fourth set of hops, of the third set of hops, that have carbon intensities greater than a carbon threshold (block 690). The carbon threshold may be indicative of a minimum acceptable carbon intensity for a hop to be considered to have a low environmental impact. In still yet additional embodiments, the energy score may be configured to indicate a number of hops of the network path that have carbon intensities greater than the carbon threshold. Thus, the energy score may be defined as a number of hops of the fourth set of hops divided by a number of hops of the first set of hops.

Although a specific embodiment for determining network path energy scores using hop filtering at each stage suitable for carrying out the various steps, processes, methods, and operations described herein is discussed with respect to FIG. 6, any of a variety of systems and/or processes may be utilized in accordance with embodiments of the disclosure. For example, the location threshold, the energy source threshold, and the carbon threshold may be percentage values. The elements depicted in FIG. 6 may also be interchangeable with other elements of FIGS. 1-5 and 7-9 as required to realize a particularly desired embodiment.

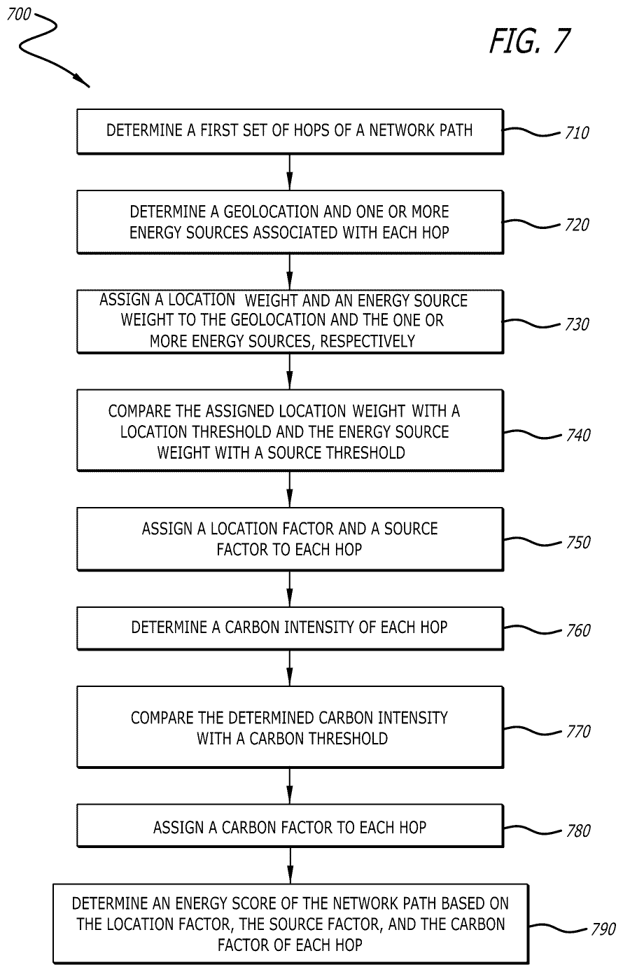

Referring to FIG. 7, a process 700 for determining factor-based energy scores of network paths in accordance with various embodiments of the disclosure is shown. In many embodiments, the process 700 may determine a first set of hops of a network path (block 710). The network path refers to the routes that data packets travel from a source to a destination. The first set of hops may include hops that are within a threshold range of at least one hop of a reference topology associated with the network path. The first set of hops may include hops identified in the network path as well as additional predicted hops.

In a number of embodiments, the process 700 may determine a geolocation and one or more energy sources associated with each hop (block 720). In some more embodiments, the geolocation of a hop may be determined using various systems such as ThousandEyes®, Skylight™, or the like. In yet more embodiments, the one or more energy sources may be determined based on information obtained directly from power companies, International Energy Agency information, third-party service (e.g., www.electricitymaps.com) non-estimated energy information, and third-party service estimated information. In still yet more embodiments, the one or more energy sources may be determined by probing the corresponding hop.

In a variety of embodiments, the process 700 may assign a location weight and an energy source weight to the geolocation and the one or more energy sources, respectively (block 730). In many further embodiments, the location weight may be assigned based on the confidence or accuracy of the geolocation determination. In many additional embodiments, the energy source weight may be assigned based on how the energy sources are determined for a hop.

In more embodiments, the process 700 may compare the assigned location weight with a location threshold and the energy source weight with an energy source threshold (block 740). The location threshold may be indicative of a minimum acceptable location weight. The energy source threshold may be indicative of a minimum acceptable energy source weight.

In additional embodiments, the process 700 may assign a location factor and an energy source factor to each hop (block 750). The location factor may be assigned based on the comparison of the location weight with the location threshold. In still yet further embodiments, the location factor may indicate whether the location weight is greater than the location threshold. In an example, the location factor may be higher if the location weight is greater than the location threshold. Similarly, the energy source factor may be assigned based on the comparison of the energy source weight with the energy source threshold. In still yet additional embodiments, the energy source factor may indicate whether the energy source weight is greater than the energy source threshold. In an example, the energy source factor may be higher if the energy source weight is greater than the energy source threshold.

In further embodiments, the process 700 may determine a carbon intensity of each hop (block 760). In several embodiments, the carbon intensity may be determined based on the one or more energy sources. More specifically, the carbon intensity may be determined based on the types of the one or more energy sources.

In still more embodiments, the process 700 may compare the determined carbon intensity with a carbon threshold (block 770). The carbon threshold may be indicative of a minimum acceptable carbon intensity for a hop to be considered to have a low environmental impact. Based on the comparison, it can be determined whether the carbon intensity is greater than the carbon threshold.

In still further embodiments, the process 700 may assign a carbon factor to each hop (block 780). The carbon factor may be assigned based on the comparison of the carbon intensity with the carbon threshold. In several more embodiments, the carbon factor may indicate whether the carbon intensity is greater than the carbon threshold. In an example, the carbon factor may be higher if the carbon intensity is greater than the carbon threshold.

In still additional embodiments, the process 700 may determine an energy score of the network path based on the location factor, the energy source factor, and the carbon factor of each hop (block 790). The energy score is thus a function of the assigned location factor, the assigned energy source factor, and the assigned carbon factor. The energy score of the network path may be utilized for selecting the network path for traffic routing.

Although a specific embodiment for determining factor-based energy scores of network paths suitable for carrying out the various steps, processes, methods, and operations described herein is discussed with respect to FIG. 7, any of a variety of systems and/or processes may be utilized in accordance with embodiments of the disclosure. For example, the location, source, and carbon thresholds may be equal or different. The elements depicted in FIG. 7 may also be interchangeable with other elements of FIGS. 1-6, 8, and 9 as required to realize a particularly desired embodiment.

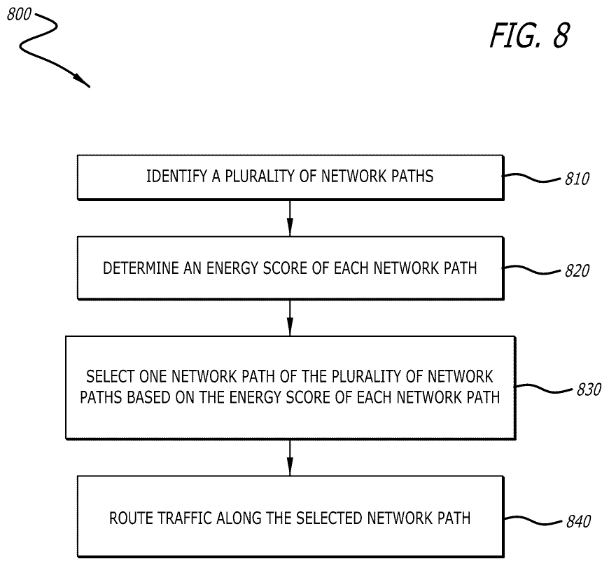

Referring to FIG. 8, a process 800 for routing traffic in a network using energy scores of network paths in accordance with various embodiments of the disclosure is shown. In many embodiments, the process 800 may identify a plurality of network paths (block 810). A network path refers to routes that data packets travel from a source to a destination. Each network path may include at least one hop.

In a number of embodiments, the process 800 may determine an energy score of each network path (block 820). The energy score of each network path may be determined based on a set of energy parameters associated with the at least one hop and one or more weights associated with the set of energy parameters. A weight may correspond to an accuracy of or a level of confidence in the determined energy parameter.

In a variety of embodiments, the process 800 may select one network path of the plurality of network paths based on the energy score of each network path (block 830). In an example, a network path having the highest energy score may be selected. Thus, in the present disclosure, the energy score is utilized to identify a network path with more probability of using less carbon.

In more embodiments, the process 800 may route traffic along the selected network path (block 840). Routing traffic along the selected network path may result in a lesser carbon footprint of the network. A higher level of sustainability can thus be achieved.

Although a specific embodiment for routing traffic in a network using energy scores of network paths suitable for carrying out the various steps, processes, methods, and operations described herein is discussed with respect to FIG. 8, any of a variety of systems and/or processes may be utilized in accordance with embodiments of the disclosure. For example, a network topology of each network path may be compared with a reference topology to further determine the energy score. The elements depicted in FIG. 8 may also be interchangeable with other elements of FIGS. 1-7 and 9 as required to realize a particularly desired embodiment.

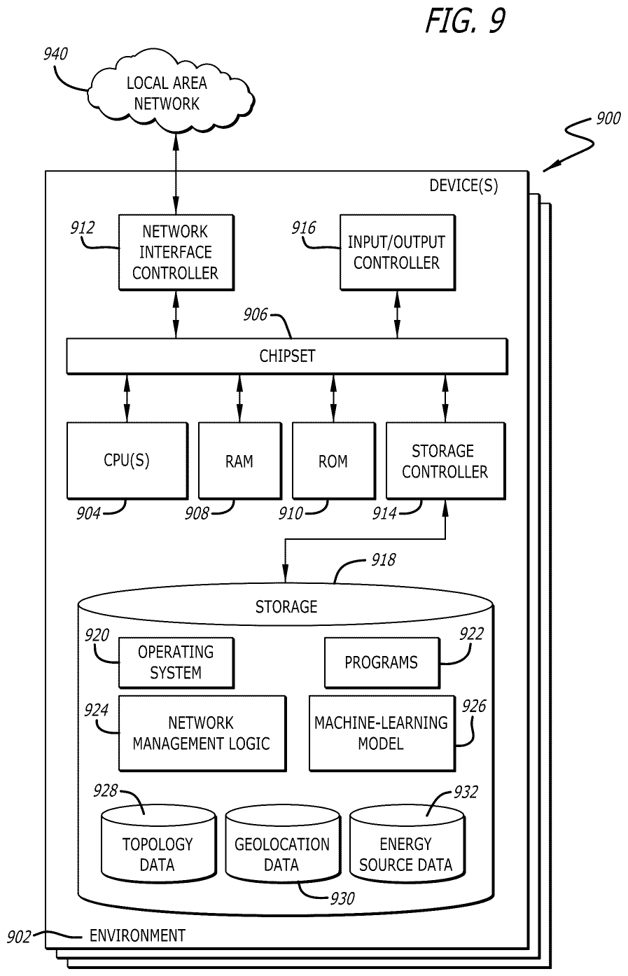

Referring to FIG. 9, a conceptual block diagram for one or more devices 900 capable of executing components and logic for implementing the functionality and embodiments described above is shown. The embodiment of the conceptual block diagram depicted in FIG. 9 can illustrate a conventional server computer, workstation, desktop computer, laptop, tablet, network appliance, e-reader, smartphone, or other computing device, and can be utilized to execute any of the application and/or logic components presented herein. The device 900 may, in some examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”), can be configured to operate in conjunction with a chipset 906. The processor(s) 904 can be standard programmable CPUs that perform arithmetic and logical operations necessary for the operation of the device 900.

In additional embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 906 may provide an interface between the processor(s) 904 and the remainder of the components and devices within the environment 902. The chipset 906 can provide an interface to random-access-memory (“RAM”) 908, which can be used as the main memory in the device 900 in some embodiments. The chipset 906 can further be configured to provide an interface to a computer-readable storage medium such as read-only memory (“ROM”) 910 or Non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Different embodiments of the device 900 can be configured to operate in a networked environment using logical connections to remote computing devices and computer systems through a network, such as the network 940. The chipset 906 can include functionality for providing network connectivity through a network interface controller (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for example, store an operating system 920, applications 922, and data 928, 930, and 932, which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

For example, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In various embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as applications 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In more embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9, and can include other components that are not explicitly shown in FIG. 9, or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more VMs running on the device 900 to perform functions described herein. The virtualization layer may generally support a virtual resource that performs at least a portion of the techniques described herein.

In many embodiments, the device 900 can include a network management logic 924 that can be configured to perform one or more of the various steps, processes, operations, and/or other methods that are described above. Often, the network management logic 924 can be a set of instructions stored within a non-volatile memory that, when executed by the processor(s)/controller(s) 904 can carry out these steps, etc. In some embodiments, the network management logic 924 may be a client application that resides on a network-connected device, such as, but not limited to, a server, switch, personal or mobile computing device, or an access point.

In certain embodiments, the network management logic 924 may identify a plurality of network paths in a network. Each network path may include one or more hops. The one or more hops of the network path may conform to a network topology. The network management logic 924 may compare the network topology with a reference topology associated with the network path. A hop of the network path is selected for energy score determination in response to a position of the hop in the network topology being within a threshold range of a position of another hop in the reference topology. The network management logic 924 may determine a set of energy parameters associated with each selected hop of the network path and assign one or more weights to the determined set of energy parameters. A weight may correspond to an accuracy of or a level of confidence in the determined energy parameter.

The set of energy parameters of a hop may include at least one of a geolocation or one or more energy sources associated with the hop. The one or more weights may similarly include at least one of a location weight or an energy source weight. The location weight may be assigned to the determined geolocation and the energy source weight may be assigned to the determined one or more energy sources. The network management logic 924 may determine an energy score of the network path based on the determined set of energy parameters and the assigned one or more weights associated with each selected hop of the network path. The energy score of the network path can be a measure of the environmental impact of the network path. The network management logic 924 may select one network path based on the energy scores and route traffic along the selected network path.

In a number of embodiments, the storage 918 can include topology data 928. The topology data 928 may include the network topologies to which one or more hops of the identified network path and predicted hops in the network path conform. The topology data 928 may include reference topologies obtained from various service providers servicing the regions encompassed by various network paths of a network.

In various embodiments, the storage 918 can include geolocation data 930. The geolocation data 930 may include locations of various hops of a network path. The geolocation data 930 may be determined using various systems such as ThousandEyes®, Skylight™, or the like. The geolocation data 930 may be utilized to determine the energy sources of the hops.

In a number of embodiments, the storage 918 can include energy source data 932. The energy source data 932 may include information obtained directly from power companies, International Energy Agency information, third-party service (e.g., www.electricitymaps.com) non-estimated energy information, and third-party service estimated information. The energy source data 932 may be utilized to determine the environmental impact of a network.

Finally, in many embodiments, data may be processed into a format usable by an ML model 926 (e.g., feature vectors), and or other processing techniques. The ML model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926. The ML model 926 may be configured to learn position nearness patterns for various hops based on data related to historical topology comparisons, and predict hops which are recurringly outside a threshold range of any hop in the reference topology. Such predictions may be utilized to eliminate these hops from the energy score determination at the outset, thereby reducing processing time.

The ML model(s) 926 can be configured to generate inferences to make predictions or draw conclusions from data. An inference can be considered the output of a process of applying a model to new data. This can occur by learning from data and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with a network management logic for carrying out the various steps, processes, methods, and operations described herein is discussed with respect to FIG. 9, any of a variety of systems and/or processes may be utilized in accordance with embodiments of the disclosure. For example, the device 900 may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a network management logic that is configured to:
identify, in the network, at least one network path comprising one or more hops;
determine a set of energy parameters associated with at least one hop of the one or more hops;
assign one or more weights to the determined set of energy parameters; and
determine an energy score of the at least one network path based on the determined set of energy parameters and the assigned one or more weights.

2. The device of claim 1, wherein the network management logic is further configured to route traffic along the at least one network path based on the determined energy score.

3. The device of claim 1, wherein determining the energy score based on the determined set of energy parameters and the assigned one or more weights comprises:
comparing the assigned one or more weights with a weight threshold; and
determining, in response to the assigned one or more weights being greater than the weight threshold, a carbon intensity of the at least one hop based on the determined set of energy parameters, wherein the energy score of the at least one network path is determined based on the carbon intensity of the at least one hop.

4. The device of claim 1, wherein the energy score is configured to indicate a number of hops of the at least one network path that have carbon intensities greater than a carbon threshold.

5. The device of claim 1, wherein the one or more hops conform to a network topology.

6. The device of claim 5, wherein the network management logic is further configured to compare the network topology with a reference topology associated with the at least one network path.

7. The device of claim 6, wherein the set of energy parameters associated with the at least one hop is determined in response to the at least one hop in the network topology being within a threshold range of another hop in the reference topology.

8. The device of claim 1, wherein to determine the energy score of the at least one network path, the network management logic is further configured to determine presence of one or more additional hops in the at least one network path along with the one or more hops, and wherein the energy score of the at least one network path is further determined based on the one or more additional hops.

9. The device of claim 1, wherein the set of energy parameters comprises at least one of a geolocation or one or more energy sources associated with the at least one hop.

10. The device of claim 9, wherein the network management logic is further configured to determine the one or more energy sources based on the geolocation.

11. The device of claim 9, wherein in response to the set of energy parameters comprising the geolocation associated with the at least one hop, the one or more weights comprise a location weight assigned to the geolocation.

12. The device of claim 11, wherein the network management logic is further configured to compare the location weight with a location threshold, and wherein the one or more energy sources associated with the at least one hop are determined in response to the location weight being greater than the location threshold.

13. The device of claim 11, wherein in response to the set of energy parameters comprising the one or more energy sources associated with the at least one hop, the one or more weights comprise an energy source weight assigned to the one or more energy sources.

14. The device of claim 13, wherein the network management logic is further configured to:
compare the energy source weight with an energy source threshold; and
determine, in response to the energy source weight being greater than the energy source threshold, a carbon intensity of the at least one hop based on the one or more energy sources.

15. The device of claim 13, wherein the network management logic is further configured to:
compare the location weight with a location threshold; and
assign a location factor to the at least one hop based on the comparison of the location weight with the location threshold.

16. The device of claim 15, wherein the network management logic is further configured to:
compare the energy source weight with an energy source threshold; and
assign an energy source factor to the at least one hop based on the comparison of the energy source weight with the energy source threshold.

17. The device of claim 16, wherein the network management logic is further configured to:
determine a carbon intensity associated with the at least one hop based on the one or more energy sources;
compare the determined carbon intensity with a carbon threshold; and
assign a carbon factor to the at least one hop based on the comparison of the determined carbon intensity with the carbon threshold.

18. The device of claim 17, wherein the energy score is a function of the assigned location factor, the assigned energy source factor, and the assigned carbon factor.

19. A device, comprising:
a processor;
a network interface controller configured to provide access to a network; and
a memory communicatively coupled to the processor, wherein the memory comprises a network management logic that is configured to:
identify, in the network, a plurality of network paths, wherein each network path of the plurality of network paths comprises at least one hop;
determine an energy score of each network path based on a set of energy parameters associated with the at least one hop and one or more weights associated with the set of energy parameters;
select one of the plurality of network paths based on the energy score of each network path; and
route traffic along the selected network path.

20. A method, comprising:
identifying, in a network, at least one network path comprising one or more hops;
determining a set of energy parameters associated with at least one hop of the one or more hops;
assigning one or more weights to the determined set of energy parameters; and
determining an energy score of the at least one network path based on the determined set of energy parameters and the assigned one or more weights.
